(19) United States
(12) Patent Application Publication
(10) Pub. No.: US 2026/0319712 A1
(43) Pub. Date: Oct. 15, 2026

(54) STORAGE SYSTEM AND STORAGE CONTROL METHOD

(71) Applicant: Hitachi Vantara, Ltd., Kanagawa-ken (JP)

(72) Inventors: Ahmad AVAIS, Tokyo (JP); Kaori NAKANO, Tokyo (JP); Shinichi HAYASHI, Tokyo (JP)

(21) Appl. No.: 19/540,241

(22) Filed: Feb. 13, 2026

(30) Foreign Application Priority Data
Apr. 9, 2025 (JP) 2025-064078

(51) Int. Cl. G06F 3/06; G06F 11/20

(52) U.S. Cl. CPC G06F 3/067; G06F 11/2064

(57) ABSTRACT

A management system includes a management function unit that detects a particular event and that acquires a snapshot volume of any one of volumes in a cloud storage device. The management function unit specifies, using detection of the particular event as a trigger, at least some on-premises primary volumes related to the particular event among a plurality of on-premises volumes in an on-premises storage device and creates secondary volumes by acquiring snapshots of a plurality of cloud primary volumes in the cloud storage device.

### CROSS REFERENCE TO RELATED APPLICATION

This application relates to and claims the benefit of priority from Japanese Patent Application number 2025-064078, filed on Apr. 9, 2025 the entire disclosure of which is incorporated herein by reference.

### BACKGROUND OF THE INVENTION

### 1. Field of the Invention

The present invention relates to a storage system and a storage control method, and particularly, is preferably applicable, in a field that intensifies cooperation between development and operations, or what is called a DevOps field, to a storage system relative to a technology of acquiring snapshots in order to deploy test environments.

### 2. Description of the Related Art

U.S. Patent No. 9703694B2 (hereinafter, Patent Document 1) discloses a technology with regard to an event-driven approach for acquiring snapshots in order to construct a test environment for software.

Snapshots are a function that is triggered by predefined events such as errors or exceptions to capture the state of the test environment for software debugging (see Patent Document 1, for example).

However, the technology disclosed in Patent Document 1 focuses on testing when software suffers an error, and lacks support for, for example, changes in database schemas, system update detections, and changes in database environments. Consequently, the technology disclosed in Patent Document 1 has been incapable of easily specifying volumes from which to acquire snapshots necessary to deploy test environments in such situations.

### SUMMARY OF THE INVENTION

It is therefore an object of the present invention to provide a storage system and a storage control method that are capable of easily specifying volumes from which to acquire snapshots necessary to deploy test environments.

In order to accomplish the above object, there is provided in accordance with an aspect of the present invention a storage system including an on-premises storage device having a plurality of on-premises volumes, a cloud storage device having a plurality of cloud volumes, and a management system that manages the plurality of on-premises volumes in the on-premises storage device and the plurality of cloud volumes in the cloud storage device and manages a function of transferring data from the plurality of on-premises volumes to the plurality of cloud volumes. The management system includes a management function unit that detects a particular event and that acquires a snapshot volume of any one of the volumes in the cloud storage device. The management function unit specifies, using detection of the particular event as a trigger, at least some on-premises primary volumes related to the particular event among the plurality of on-premises volumes in the on-premises storage device and creates secondary volumes by acquiring snapshots of cloud primary volumes in the cloud storage device.

There is also provided in accordance with another aspect of the present invention a storage control method for a storage system that includes an on-premises storage device having a plurality of on-premises volumes, a cloud storage device having a plurality of cloud volumes, and a management system that manages the plurality of on-premises volumes in the on-premises storage device and the plurality of cloud volumes in the cloud storage device and manages a function of transferring data from the plurality of on-premises volumes to the plurality of cloud volumes. The management system includes a management function unit that detects a particular event and that acquires a snapshot volume of any one of the volumes in the cloud storage device. The method includes, by the management function unit, specifying, using detection of the particular event as a trigger, at least some on-premises primary volumes related to the particular event among the plurality of on-premises volumes in the on-premises storage device and creating secondary volumes by acquiring snapshots of a plurality of cloud primary volumes in the cloud storage device.

According to the present invention, it is easy to specify volumes from which to acquire snapshots necessary to deploy test environments.

### BRIEF DESCRIPTION OF THE DRAWINGS

FIG. 1A is a block diagram illustrating a configurational example of a storage system according to an embodiment of the present invention;

FIG. 1B is a block diagram illustrating a configurational example of an on-premises server and a cloud server illustrated in FIG. 1A;

FIG. 1C is a block diagram illustrating a configurational example of a management system illustrated in FIG. 1A;

FIG. 2A is a diagram illustrating a configurational example of an information table;

FIG. 2B is a diagram illustrating a configurational example of the information table;

FIG. 3 is a flowchart illustrating an example of a sequence of a replication creating process; and

FIG. 4 is a diagram illustrating an example of a test environment screen displayed according to the embodiment.

### DESCRIPTION OF THE PREFERRED EMBODIMENT

A preferred embodiment of the present invention will be described in detail below with reference to the drawings.

The present embodiment is illustrative of the present invention by way of example only and includes omissions and simplifications made for the sake of brevity and clarity. The present invention can be reduced to practice in various other embodiments that exemplify the principles of the invention. Unless specified otherwise, each of various components of the embodiment may be singular or plural.

The present embodiment illustrates a scenario for constructing a test environment for software debugging during system development. Note that the present embodiment is also applicable to other scenarios. According to the present embodiment, for example, a test environment that represents a copy of a live environment is created and used to perform a thorough advance examination of potential problems that could occur in the live environment, so that effective measures can be taken to make the problems less likely to happen in the live environment.

According to the present embodiment, for example, with use of triggers such as changes in database schemas, system updates, or pipeline events that may occur in continuous integration/continuous delivery (CI/CD), there are acquired snapshots that are consistent throughout all volumes that could be affected by those triggers. CI/CD refers to a kind of scheme for automating a process from the development of software to the release thereof.

The present embodiment addresses the task of securing consistency in a distributed transaction or hybrid cloud environment and optimizes the setup of a scalable automatic test environment that is compatible with latest application development workflows.

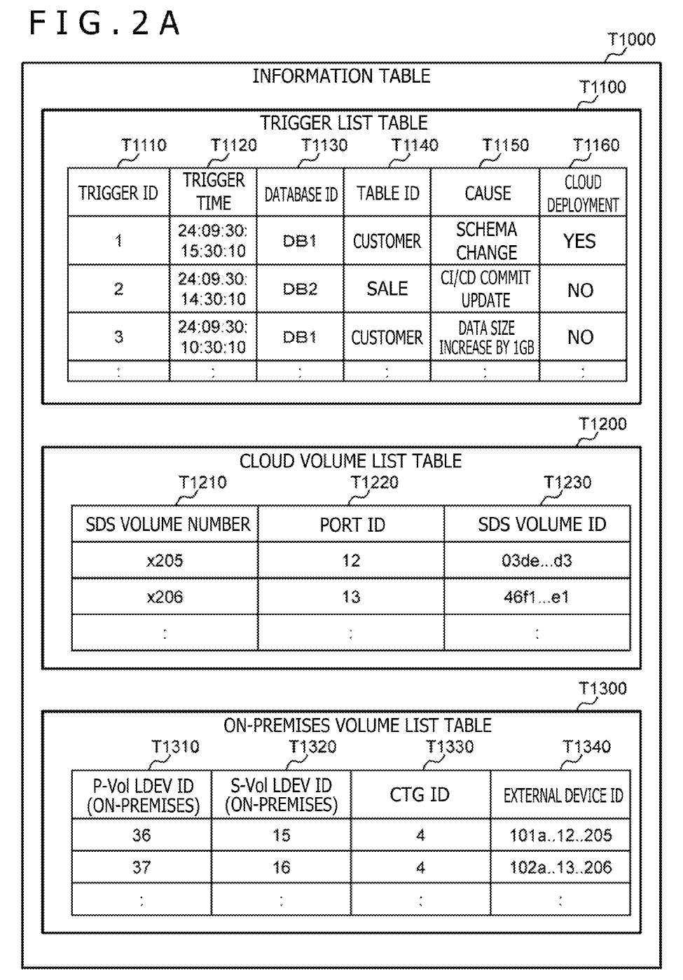

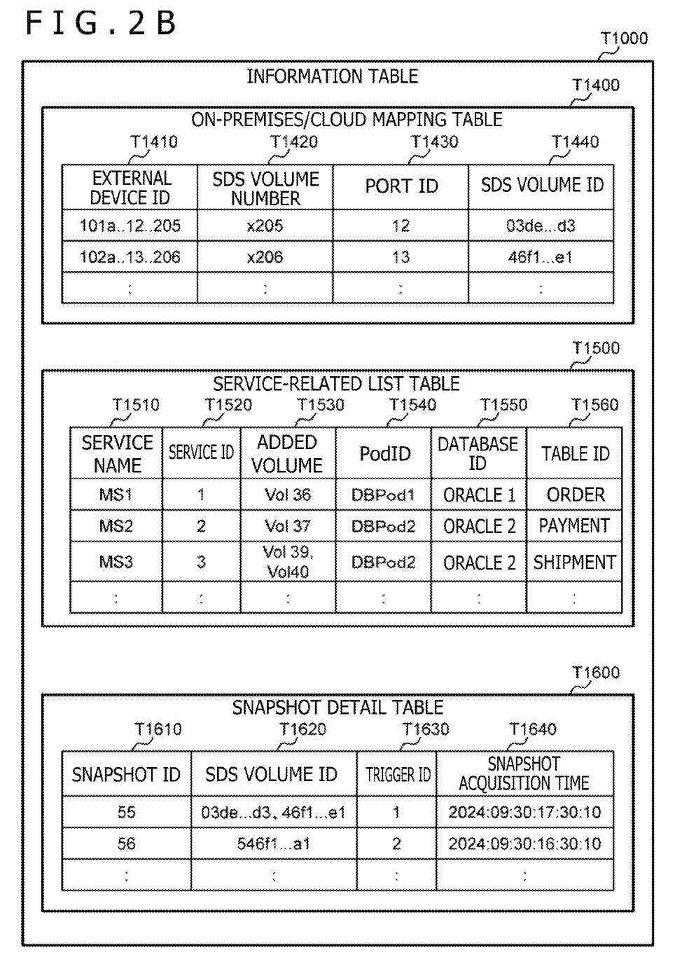

According to the present embodiment, various figures including data flow figures, system figures, tables, flowcharts, and graphical user interface (GUI) figures are included to assist in describing operation of the present invention. The tables illustrated in FIGS. 2A and 2B may be those that operate on any tools and software, may be those that represent any databases, or may be of data of formats such as extensible markup language (XML) or text.

The illustrated examples represent, in block form, use cases of volume replications from an on-premises server to a cloud server, the system infrastructure of a management system, and data transaction relations in a typical customer environment.

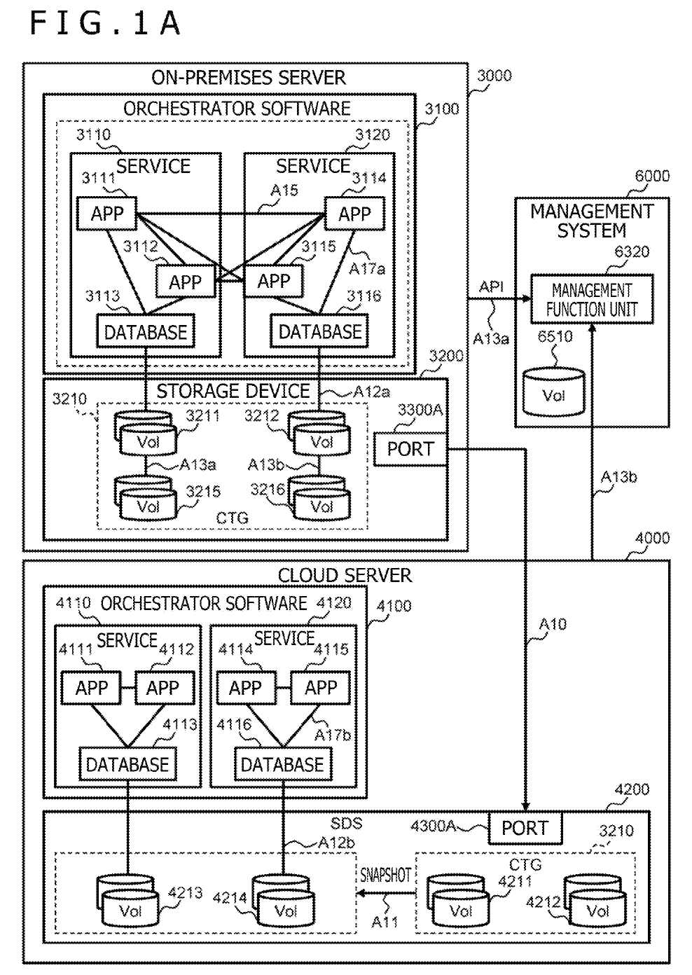

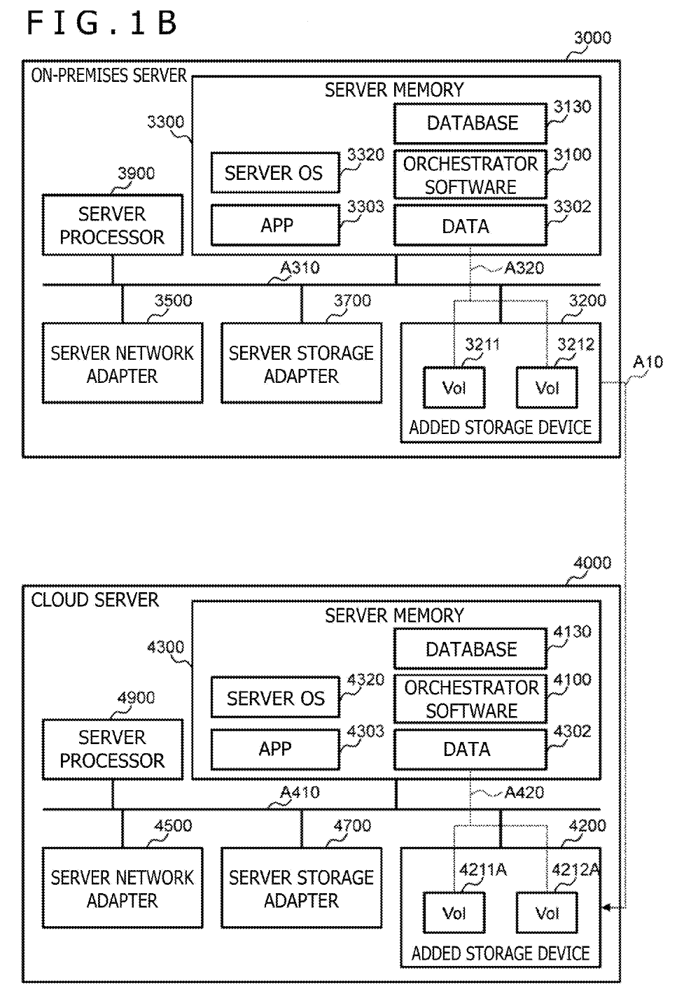

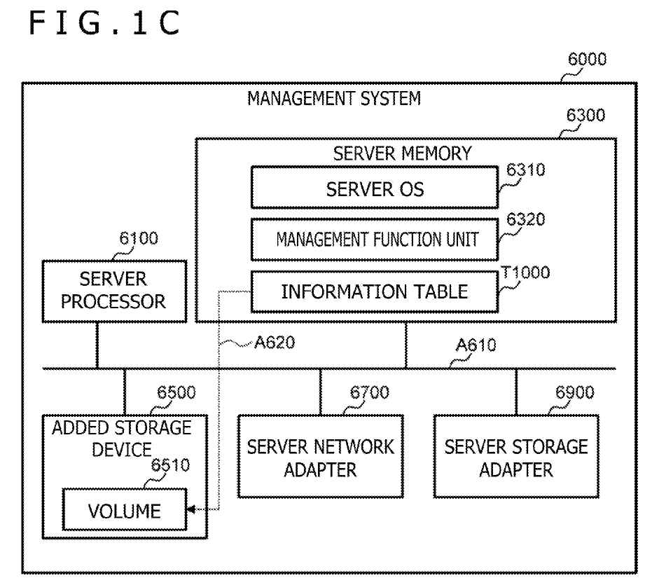

FIG. 1A is a block diagram illustrating a configurational example of a storage system according to the present embodiment. The storage system according to the present embodiment includes an on-premises server 3000, a cloud server 4000, and a management system 6000. The on-premises server 3000 as an example of on-premises storage device has a plurality of primary volumes (abbreviated to "P-VOLs") 3211, a plurality of secondary volumes (abbreviated to "S-VOLs") 3215, a plurality of P-VOLs 3212, and a plurality of S-VOLs 3216. The cloud server 4000 as a cloud-side storage device has a plurality of cloud volumes 4211 and 4212. The management system 6000 manages the P-VOLs 3211, the S-VOLs 3215, the P-VOLs 3212, and the S-VOLs 3216 in the on-premises server 3000 and the cloud volumes 4211 and 4212 in the cloud server 4000, and manages a function of transferring data from the P-VOLs 3211 and 3212 as examples of on-premises volumes to the cloud volumes 4211 and 4212. For example, the management system 6000 manages a function of establishing connection with the cloud volumes 4211 and 4212 as external devices, causing them to be virtually recognized as the S-VOLs 3215 and 3216 as examples of on-premises volumes, and transferring data from the P-VOLs 3211 and 3212 to the cloud volumes 4211 and 4212.

The management system 6000 includes a management function unit 6320 and a volume 6510. According to the present embodiment, a volume may be abbreviated to "Vol." The management function unit 6320 manages the on-premises server 3000 and the cloud server 4000 by using the volume 6510.

The storage system according to the present embodiment includes a plurality of instances of the on-premises server 3000 and the cloud server 4000. The on-premises server 3000 runs orchestrator software 3100 such as Kubernetes (registered trademark) and OpenShift (registered trademark), for example. The cloud server runs orchestrator software 4100 such as Kubernetes (registered trademark) and OpenShift (registered trademark), for example. Alternatively, the on-premises server 3000 and the cloud server 4000 may each, instead of using the orchestrator software 3100 and the orchestrator software 4100, execute an operating system and applications (which may be abbreviated to "apps") directly on bare metal, i.e., a physical server provided as hardware, without the use of virtualization.

The orchestrator software 3100 of the on-premises server 3000 includes a service 3110, a service 3120, and an added storage device 3200. The service 3110 includes apps 3111 and 3112 and a database 3113. The apps 3111 and 3112 provide certain services by using the database 3113. The service 3120 includes apps 3114 and 3115 and a database 3116. The apps 3114 and 3115 provide certain services by using the database 3116.

The added storage device 3200 includes the primary volumes (each also depicted as "Vol" in figures) 3211 and 3212 and the secondary volumes (each also depicted as "Vol" in figures) 3215 and 3216 that belong to a consistency group (which may be abbreviated to a "CTG") 3210.

The added storage device 3200 includes a port 3300A. The port 3300A represents an Internet small computer systems interface/fiber channel (iSCSI/FC), for example, and is connected to a port 4300A of software-defined storage (SDS) 4200 of the cloud server 4000 by a network cable, not depicted.

The orchestrator software 4100 of the cloud server 4000 includes a service 4110, a service 4120, and the SDS 4200. The service 4110 includes apps 4111 and 4112 and a database 4113. The apps 4111 and 4112 provide certain services by using the database 4113. The service 4120 includes apps 4114 and 4115 and a database 4116. The apps 4114 and 4115 provide certain services by using the database 4116.

The SDS 4200, which is also referred to as the "added storage device 4200," includes volumes (each also depicted as "Vol" in figures) 4213 and 4214 created from the P-VOLs 4211 and 4212 (also referred to as the "cloud volumes 4211 and 4212") as examples of cloud volumes by a snapshot process A11.

The added storage device 4200 includes the port 4300A referred to above. The port 4300A represents an iSCSI/FC, for example, and is connected to the port 3300A of the added storage device 3200 of the on-premises server 3000 by the network cable, not depicted.

A network connection A10 refers to a logical network connection for detecting an external device of the cloud server 4000 as a remote site with external device manager software (hereinafter abbreviated to an "external device manager") and sending and receiving data to and from the external device as the remote site via the ports 3300A and 4300A. The external device manager represents software that recognizes a device (volume) in the cloud server 4000 and causes the device to be recognized as a virtual storage device in the on-premises server 3000. Actual data that is recorded in the cloud server 4000 can be recognized as local data by the on-premises server 3000. The external device manager may be, for example, the universal volume manager manufactured by Hitachi, Ltd. A volume detected in the cloud server 4000 can be used for a local replication, for example, as is the case with a local volume in the on-premises server 3000.

According to the present embodiment, the volumes 4211 and 4212 in the cloud server 4000 are recognized as the volumes 3215 and 3216 in the on-premises server 300. These volumes 3215 and 3216 are virtual volumes, for example, whose actual data storage areas are provided by the cloud volumes 4211 and 4212 in the cloud server 4000. The volumes 3215 and 3216 function as secondary volumes of copy pairs (e.g., Hitachi Shadow Image) A13a and A13b in order to copy data from the volumes 3211 and 3212. Therefore, data is transferred from the volumes 3211 and 3212 in the on-premises server 3000 to the volumes 4211 and 4212 in the cloud server 4000, so that the latest data is continuously copied from the on-premises server 3000 to the cloud server 4000.

A mounting process A12a refers to a process of mounting data in the on-premises volume 3212. A mounting process A12b refers to a process of mounting data in the cloud volume 4214. The snapshot process A11 refers to a process of snapshotting data from the volumes 4211 and 4212 that belong to a consistency group to the volumes 4213 and 4124. The copy pair A13a is assisted by an application programming interface (API), for example, to acquire related information from the added storage device 3200. The copy pair A13b is assisted by the API, for example, to acquire related information from the added storage device 3200.

A distributed transaction A15 represents a distributed transaction between the services 3110 and 3120 that are microservices and the app 3111. All the volumes 3211, 3212, 3125, and 3216 in the services 3110 and 3120 related to each other by the distributed transaction A15 are set in one CTG 3210, for example. Relations A17a and A17b represent relations between the apps 3111 and 3114 or Pods.

The apps 3111 and 3112, the database 3113, the apps 3114 and 3115, and the database 3116 are a set of the apps 3111, 3112, 3114, and 3115 or the Pods of the orchestrator software 3100 that runs the apps 3111 and 3114 or the databases 3113 and 3116 in the on-premises server 3000.

The apps 4111 and 4112, the database 4113, the apps 4114 and 4115, and the database 4116 are a set of the apps 4111, 4112, 4114, and 4115 or the Pods of the orchestrator software 4100 that runs the apps 4111, 4112, 4114, and 4115 or the databases 4113 and 4116 in the cloud server 4000.

The CTG 3210 refers to a consistency group representing a set of volumes that are to be held consistent with each other. The added storage device 4200 is any storage in the cloud server 4000. According to the present embodiment, SDS in the cloud server 4000 is used as the added storage device 4200.

Each of the orchestrator software 3100 and the orchestrator software 4100 such as Kubernetes (registered trademark) refers to software designed to automate and adjust deployment, scaling, and management of containerized applications. According to Kubernetes (registered trademark), containers are grouped into units called "Pods" that represent minimum objects that can be deployed in a cluster. Each Pod stores one or more containers closely related to each other that share a network and a storage device, and the containers are run in unison with each other. Since the orchestrator software 3100 and the orchestrator software 4100 can continuously monitor the Pods and automatically change their scheduling and scaling depending on work load changes and faults, the overall system can be operated efficiently and highly reliably.

A primary volume (P-VOL) refers to a main storage volume used by an application or a system to read data therefrom and write data therein. A secondary volume (S-VOL) refers to a duplicate copy that is kept for the purpose of backup and failover. Changes added to the P-VOL are mirrored by the S-VOL to keep the data in both volumes consistent with each other, making possible a scenario for high availability and disaster recovery.

A copy pair is made up of two volumes, i.e., a P-VOL and an S-VOL. All operations of writing data in the P-VOL are replicated to the S-VOL according to replication settings (e.g., synchronous or asynchronous settings) that are defined in advance. By mirroring data from the P-VOL to the S-VOL, the copy pair guarantees that the S-VOL has a latest or nearly latest copy of the data of the P-VOL. The copy pair can be used for backup, failover, and disaster recovery, for example.

A consistency group refers to a mechanism for grouping one or more copy pairs including P-VOLs and S-VOLs that share one consistency group identifier (hereinafter also referred to as a "CTGID"). A P-VOL refers to a main storage volume that is used to read data therefrom and write data therein. An S-VOL refers to a duplicate copy that is kept for the purposes of backup and failover.

The present embodiment is based on the assumption that, when an application or a database uses a plurality of volumes, all data are written in the volumes according to the order in which write requests are issued. The consistency group of the storage system according to the present embodiment guarantees that copied data are written in S-VOLs according to the order in which the data are written in corresponding P-VOLs. Guaranteeing the synchronized order in which to write data is important particularly for mission-critical operations.

According to the present embodiment, when duplicate data are stored in S-VOLs in the same order as the order in which the data are written from a database to P-VOLs, the consistency of the data is guaranteed.

A distributed transaction refers to a sequence of operations that spans a plurality of database servers or storage systems, all of which are required to succeed or fail as a single unit to maintain data consistency. In other words, every participating component in the distributed transaction is required to either commit changes or roll them back together, ensuring integrity across the entire distributed environment.

For example, it is assumed that a plurality of microservices that run different applications exist in a certain organization. A subset of these microservices may possibly be involved in a single transaction that depends on individual operations of each of the microservices. For example, a microservice takes charge of creating an order and then calls another microservice to verify the payment, which in turn calls still another microservice to update the inventory. The sequence of these steps causes each of the microservices to modify its database. In the event of a failure of part of the process, the storage system according to the present embodiment has to roll back all the changes and control each relevant database to revert to its original state prior to the transaction.

To maintain data consistency and protect duplicated data across the databases, all the volumes belonging to the distributed transaction need to be grouped under a single consistency group. By assigning P-VOLs and corresponding S-VOLs in the microservices to the same consistency group, written data are synchronized in both the P-VOLS and the S-VOLS. In the event of a failure, this performs rollbacks consistently and aligns the data replicated to all the S-VOLs with the original transaction state. Cases where such data consistency is necessary are required not only in configurations where a distributed transaction is realized by a plurality of databases, but also in configurations where the data of a single database is distributed and stored in a plurality of storage devices.

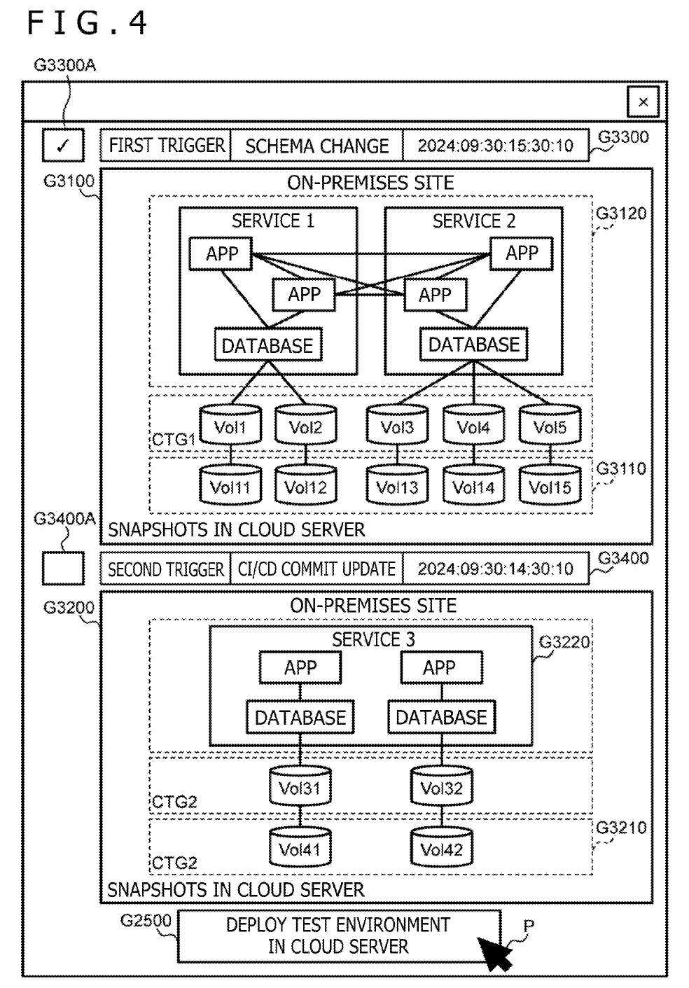

The management system 6000 refers to a server that controls the on-premises server 3000 and the cloud server 4000 by operating the management function unit 6320 and saves related data in the volume 6510. The relation between the volume 6510 and snapshots can be visualized by a GUI illustrated in FIG. 4 to be described later.

The illustrated example indicates each system existing in a customer environment and components included in the system. The customer environment contains a number of local servers and remote servers. Local servers and remote servers exist as cloud and on-premises servers. The customer environment has at least one on-premises server 3000, at least one cloud server 4000, and a management system 6000.

In the customer environment, at least one on-premises server 3000 is running. A target that needs to be protected by way of replication is a server acting as a source of a service and/or data being executed. According to a typical example, such a target represents an on-premises local server (on-premises server 3000) whose data need to be replicated (restored) to a remote cloud server.

In the management system 6000, the management function unit 6320 detects a particular event and acquires a snapshot volume of any of the volumes in the cloud server 4000 as an example of a cloud storage device. The management function unit 6320 is triggered by the detection of the particular event to specify at least some on-premises primary volumes (e.g., the P-VOLs 3211 and 3212) related to the particular event among the P-VOLs 3211 and 3212 in the on-premises server 3000.

The management function unit 6320 splits the copy pairs of the P-VOLs 3211 and 3212 as examples of at least some on-premises primary volumes that have been specified and the cloud volumes 4211 and 4212. Thereafter, the management function unit 6320 creates secondary volumes (hereinafter abbreviated to "S-VOLs") 4213 and 4214 by acquiring snapshots of the P-VOLs 4211 and 4212 connected as external devices, for example, in the cloud server 4000, and synchronizes again the copy pairs of the P-VOLs 3211 and 3212 as examples of on-premises volumes and the cloud volumes 4211 and 4212. Alternatively, the management function unit 6320 may create the S-VOLs 4213 and 4214 as described above without splitting the copy pairs of the specified P-VOLs 3211 and 3212 and the cloud volumes 4211 and 4212. The management function unit 6320 specifies the consistency group 3210 to which at least some on-premises primary volumes that have been specified (e.g., the P-VOL 3211) belong, splits the S-VOL 3215 and the S-VOL 3216 from the copy pairs with the P-VOL 3211 and the P-VOL 3212 that belong to the consistency group 3210, i.e., splits the copy pairs A13a and A13b, creates S-VOLs 4213 and 4214 by acquiring snapshots of the P-VOL 4211 and the P-VOL 4212 as examples of cloud volumes connected as external devices, for example, in the cloud server 4000 that provides the actual data storage areas for the S-VOL 3215 and the S-VOL 3216, and synchronizes again the copy pairs of the P-VOLs 3211 and 3212 as examples of on-premises volumes and the cloud volumes 4211 and 4212.

The management function unit 6320 detects changes in the schemas of the P-VOLs 3211 and 3212 used in the databases, for example, as a particular event.

The management function unit 6320 detects an event (pipeline event) that may occur in CI/CD, for example, as a particular event.

The management function unit 6320 detects a change in a data definition language (DDL) as a particular event.

The management function unit 6320 starts creating a snapshot volume on the basis of a detected particular trigger while keeping alignment between the volumes included in the consistency group 3210.

FIG. 1B is a block diagram illustrating a configurational example of the on-premises server 3000 and the cloud server 4000 illustrated in FIG. 1A. The on-premises server 3000 and the cloud server 4000 represent a local server system and a remote server system, respectively, that copy volumes while keeping consistency groups consistently.

An arrow A320 in FIG. 1B indicates the relation of data in a database 3130 stored in the volumes 3211 and 3212. An arrow A420 indicates the relation of data in a database 4130 stored in the volumes 4211 and 4212. The databases 3130 and 4130 run on a Pod or bare metal.

In the customer environment, at least one on-premises server 3000 illustrated in FIG. 1B is running. The on-premises server 3000 includes a server memory 3300, a server processor 3900 that processes programs to be executed, a server network adapter 3500, a server storage adapter 3700, an added storage device 3200, and a bus A310. The server memory 3300, the server processor 3900 that processes programs to be executed, the server network adapter 3500, the server storage adapter 3700, and the added storage device 3200 are interconnected by the bus A310 and can exchange data and commands included in the programs with each other.

The server memory 3300 stores various types of programs and data. The server processor 3900 controls execution of programs to be executed using relevant data. The server network adapter 3500 controls connections made through the bus A310. The server storage adapter 3700 has a function of establishing connection with the added storage device 3200 that can be used on the bus A310. The server memory 3300 stores programs that are being currently executed and data 3302. Typical examples of programs that can possibly be executed on the server memory 3300 include a server operating system (hereinafter also referred to as a "server OS") 3320 and an app 3303 such as OpenShift (registered trademark) and Kubernetes (registered trademark), for example. Orchestrator software 3100 represents the app 3303 that uses the data 3302 or apps or Pods that run the database 3130.

The data 3302 is resident in the volume 3211 or the volume 3212 in the added storage device 3200 that has been connected thereto. The relation between the data 3302 and the volume 3211 or the volume 3212 is indicated by the arrow A320. The bus A310 interconnects all the components in the server system.

In the customer environment, at least one cloud server 4000 is running. The cloud server 4000 refers to a server where data and programs are duplicated in order to protect the customer environment against faults. The cloud server 4000 includes a server processor 4900, a server memory 4300, a server network adapter 4500, a server storage adapter 4700, an added storage device 4200, and a bus A410. The server processor 4900, the server memory 4300, the server network adapter 4500, the server storage adapter 4700, and the added storage device 4200 are interconnected by the bus A410 and can exchange data and commands included in the programs with each other.

The server processor 4900 processes programs to be executed. The server memory 4300 has a server OS 4320, an app 4303, a database 4130, orchestrator software 4100, and data 4302.

The server network adapter 4500 is an adapter for connection to a network, not depicted. The added storage device 4200 that can be used on the network is connected to the server storage adapter 4700.

Typical examples of programs that can be executed on the server memory 4300 include the server OS 4320 and the orchestrator software 4100 such as OpenShift (registered trademark) and Kubernetes (registered trademark) software, for example. The app 4303 refers to an application that executes a Pod or bare metal. The database 4130 refers to a database program that is run on a Pod or bare metal. The data 3302 and the data 4302 are mounted and used.

The data 4302 is saved in a volume 4211A or a volume 4212A of the added storage device 4200 that has been connected thereto. The relation between the data 4302 and the volume 4211A or the volume 4212A is indicated by the arrow A420. The volume 4211A corresponds to the volume 4211 illustrated in FIG. 1A, whereas the volume 4212A corresponds to the volume 4212 illustrated in FIG. 1A. In FIG. 1A, the volumes 4211 and 4212 are receptive of on-premises data, and no database is mounted. In FIG. 1B, a database is mounted.

The network connection A10 refers to a logical network connection for detecting an external device of a remote site with external device manager software (hereinafter abbreviated to an "external device manager") and sending and receiving data to and from the external device as the remote site.

FIG. 1C is a block diagram illustrating a configurational example of the management system 6000 illustrated in FIG. 1A. The management system 6000 includes a server processor 6100, a server memory 6300, an added storage device 6500, a server network adapter 6700, a server storage adapter 6900, and a bus A610. The server processor 6100, the server memory 6300, the added storage device 6500, the server network adapter 6700, and the server storage adapter 6900 are interconnected by the bus A610 and can exchange data and commands included in programs with each other.

The server processor 6100 controls execution of programs. The added storage device 6500 has a volume 6510. The server network adapter 6700 is an adapter for connection to a network, not depicted. The added storage device 6500 that can be used on the network is connected to the server storage adapter 6900. The volume 6510 refers to a volume created in the added storage device 6500.

The server memory 6300 has programs and data. Typical programs that are run on the server memory 6300 include a server OS 6310 and a management function unit 6320. The programs collect related information from the added storage device 3200 and the added storage device 4200, create a snapshot volume, and issue instructions to deploy a test environment. The server memory 6300 also includes an information table T1000. An arrow A620 indicates that the information table T1000 that is currently loaded in the server memory 6300 also exists in the volume 6510.

FIG. 2A is a diagram illustrating a configurational example of the information table T1000. The information table T1000 is stored in the volume 6510 in the management system 6000. The information table T1000 includes a trigger list table T1100, a cloud volume list table T1200, and an on-premises volume list table T1300.

The trigger list table T1100 manages trigger identifiers (IDs) T1110, trigger times T1120, database IDs T1130, table IDs T1140, causes T1150, and cloud deployments T1160.

The trigger list table T1100 manages changes in the DDL, for example. Changes in the DDL include a schema change, a CI/CD change, and/or a data size increase, for example. The attributes are explained below.
1. Trigger IDs (T1110): Unique identifiers of respective events.
2. Trigger times (T1120): Time stamps of events.
3. DB IDs (T1130): Identifiers of databases where events have occurred.
4. Table IDs (T1140): Tables affected within databases.
5. Causes (T1150): Event types (e.g., "Schema Change") that trigger a snapshot.
6. Cloud deployments (T1160): Flags (Yes/No) indicating cloud deployment.

The cloud volume list table T1200 manages SDS volume numbers T1210, port IDs T1220, and SDS volume IDs T1230.
1. SDS volume numbers (T1210): Identifiers of respective cloud storage volumes.
2. Port IDs (T1220): Related port numbers.
3. SDS volume IDs (T1230): System-defined unique identifiers of respective volumes.

The on-premises volume list table T1300 manages on-premises P-VOL logical device IDs (depicted as "P-Vol LDEV ID" in FIG. 2A) T1310, on-premises S-VOL logical device IDs (depicted as "S-Vol LDEV ID" in FIG. 2A) T1320, CTG IDs T1330, and external device IDs T1340. The external device IDs represent identifiers for identifying a plurality of external volumes, respectively.

The on-premises volume list table T1300 manages a list of on-premises volumes and a related alignment group. The attributes are explained below.
1. P-VOL logical volume IDs (T1310): Primary logical device IDs of on-premises storage devices.
2. S-VOL logical volume IDs (T1320): Secondary logical device ICs for replication.
3. CTG IDs (T1330): Consistency group identifiers for managing depending volumes.
4. External device IDs (T1340): Identifiers of related external devices.

According to the present embodiment, consistency groups are set with regard to P-VOLs. However, there may be P-VOLs with regard to which no consistency groups are set. If no consistency groups are set with regard to P-VOLs, then CTG IDs (T1330) are left blank, and a target whose snapshot is to be acquired may be only those P-VOLs related to databases where triggers are detected.

FIG. 2B is a diagram illustrating a configurational example of the information table T1000. The information table T1000 is stored in the volume 6510 in the management system 6000. The information table T1000 further includes an on-premises/cloud mapping table T1400, an on-premises volume service-related list table (hereinafter also referred to as a "service-related list table") T1500, and a snapshot detail table T1600.

The on-premises/cloud mapping table T1400 manages mapping from the on-premises server 3000 onto the cloud server 4000. The on-premises/cloud mapping table T1400 manages external device IDs T1410, SDS volume numbers T1420, port IDs T1430, and SDS volume IDs T1440.

The on-premises/cloud mapping table T1400 manages mapping from the on-premises server 3000 onto the cloud server 4000. The on-premises/cloud mapping table T1400 refers to a table for mapping volumes in the on-premises server 3000 onto corresponding volumes in the cloud server 4000. The on-premises/cloud mapping table T1400 uses cloud volume numbers capable of uniquely identifying volumes and external device IDs for encoding details of port IDs. The attributes are explained below.
1. External device IDs (T1410): Identifiers of on-premises external storage devices.
2. SDS volume numbers (T1420): Volume numbers of corresponding cloud storage devices.
3. Port IDs (T1430): Port identifiers for accessing cloud volumes.
4. SDS volume IDs (T1440): System-defined unique cloud volume identifiers. The service-related list table T1500 manages service names T1510, service IDs T1520, added volumes T1530, Pod IDs T1540, database IDs T1550, and table IDs T1560.

The service-related list table T1500 maps a volume in the on-premises server 3000 onto a service and/or a database. The service-related list table T1500 tracks which table depends on which volume set (hereinafter also abbreviated to a "set"). The attributes are explained below.
1. Service names (T1510): The names of services that use storage volumes.
2. Service IDs (T1520): Unique identifiers of services.
3. Added volumes (T1530): A list of on-premises volumes that are connected.
4. Pod IDs (T1540): Identifiers of Pods hosting services.
5. DB IDs (T1550): Database identifiers related to volumes.
6. Table IDs (T1560): Table identifiers in databases.

The snapshot detail table T1600 manages snapshot IDs T1610, SDS volume IDs T1620, trigger IDs T1630, and snapshot acquisition times T1640.

The snapshot detail table T1600 tracks snapshots created on the basis of triggers. The attributes are explained below.
1. Snapshot IDs (T1610): Unique identifiers of snapshots.
2. SDS volume IDs (T1620): storage volume IDs of snapshots.
3. Trigger IDs (S1630): Trigger events related to snapshots.
4. Snapshot acquisition times (T1640): Time stamps indicative of times at which snapshots are acquired.

The tables descried above are related to each other as follows.

The trigger list table T1100 is used to start a snapshot process by specifying an event that requires a snapshot.

The on-premises volume list table T1300 and the cloud volume list table T1200 specify volumes related to each other, maintaining consistency between an on-premises environment and a cloud environment.

The on-premises/cloud mapping table T1400 guarantees a seamless correlation between the on-premises environment and the cloud environment.

The service-related list table T1500 provides context information regarding services and databases affected by triggers, guaranteeing that snapshots are related to requirements for particular applications.

The snapshot detail table T1600 tracks created snapshots and provides a comprehensive audit trail representing when each of the snapshots is acquired for what purpose. This structured approach guarantees automation, traceability, and consistency in managing snapshots of databases throughout a hybrid environment of development and test pipeline.

The storage system according to the present embodiment has configurational details as described above. Now, a storage control method according to the present embodiment will be described below. First, an overview of the storage control method according to the present embodiment will be described below. The storage control method according to the present embodiment is exemplified as a storage control method for the storage system including the on-premises server 3000 as an example of an on-premises storage device having a plurality of P-VOLs 3211, S-VOLs 3215, P-VOLs 3212, and S-VOLs 3216, the cloud server 4000 as an example of a cloud storage device having a plurality of cloud volumes 4211 and 4212, and the management system 6000 for managing the P-VOLs 3211, the S-VOLs 3215, the P-VOLs 3212, and the S-VOLs 3216 in the on-premises server 3000 and the cloud volumes 4211 and 4212 in the cloud server 4000 and managing a function of transferring data from the P-VOLs 3211 and 3212 as examples of on-premises volumes to the cloud volumes 4211 and 4212. The management function unit 6320 of the management system 6000 detects a particular event and acquires a snapshot volume of any of the volumes in the cloud server 4000. The management function unit 6320 is triggered by the detection of the particular event to specify at least some on-premises primary volumes (e.g., the P-VOLs 3211 and 3212) related to the particular event among the P-VOL 3211 and the P-VOL 3212 in the on-premises server 3000. The management function unit 6320 splits the copy pairs A13a and A13b of the specified at least some on-premises primary volumes (e.g., the P-VOLs 3211 and 3212) and the cloud volumes 4211 and 4212. By thus splitting the copy pairs A13a and A13bb, the management function unit 6320 holds data of the time at which the trigger has occurred, in the S-VOL 3215 and the S-VOL 3216 (whose actual data storage areas are provided by the cloud volumes 4211 and 4212), for example. However, the management function unit 6320 may omit to split the copy pairs A13a and A13b of the specified at least some on-premises primary volumes (e.g., the P-VOLs 3211 and 3212) and the cloud volumes 4211 and 4212. Thereafter, the management function unit 6320 creates the S-VOLs 4213 and 4214 in the cloud server 4000 by acquiring snapshots of the P-VOL 4211 and the P-VOL 4212 as examples of cloud volumes, and synchronizes again the copy pairs A13a and A13b of the P-VOLs 3211 and 3212 as examples of on-premises volumes and the cloud volumes 4211 and 4212. The storage control method according to the present embodiment includes a replication creating process to be described below.

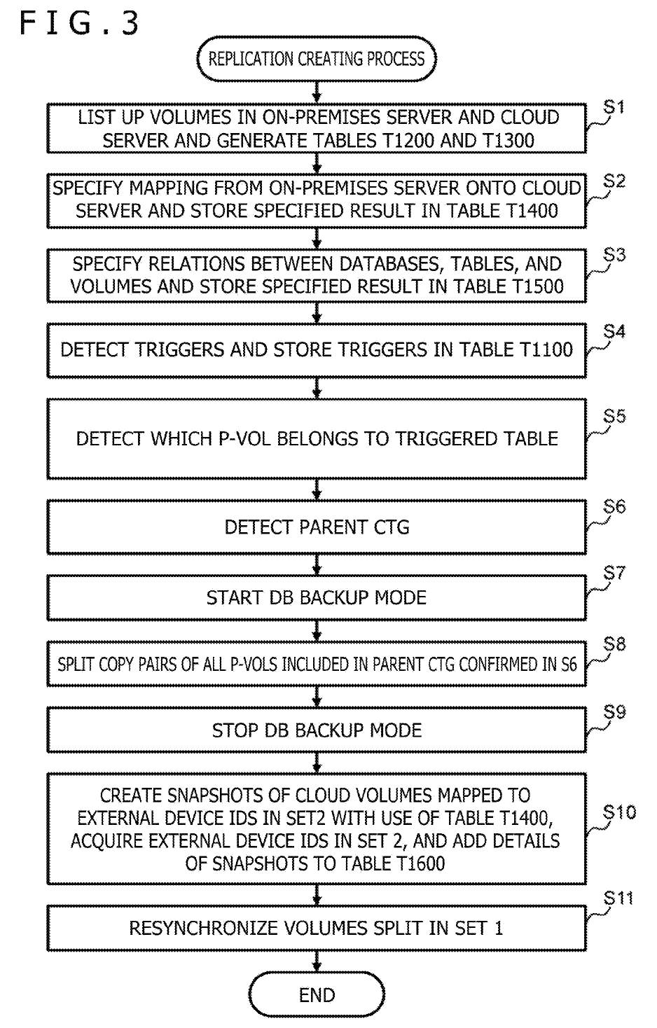

FIG. 3 is a flowchart illustrating an example of a sequence of the replication creating process. The replication creating process is performed by the management function unit 6320. The replication creating process represents by way of example a process of, providing latest data have been transferred from the on-premises server 3000 to the cloud server 4000, duplicating data from the on-premises server 3000 at a certain time in the cloud server 4000 with use of an event in the on-premises server 3000 as a trigger in order to create test data for system development in the cloud server 4000.

In step S1, the management function unit 6320 lists up all the volumes in the on-premises server 3000 and the cloud server 4000 and generates the cloud volume list table T1200 and the on-premises volume list table T1300. The volumes in the cloud server 4000 are listed up in the cloud volume list table T1200, whereas the volumes in the on-premises server 3000 are listed up in the on-premises volume list table T1300. In step S2, the management function unit 6320 specifies mapping from the on-premises server 3000 onto the cloud server 4000 and stores the specified result in the on-premises/cloud mapping table T1400. For example, mapping between the volumes in the on-premises server 3000 and the volumes in the cloud server 4000 is specified by determining whether or not SDS volume numbers are included in the SDS volume numbers (T1210) in the cloud volume list table T1200 and the external device IDs (T1340) in the on-premises volume list table T1300. If a plurality of on-premises servers 3000 and cloud servers 4000 are managed by the management function unit 6320, then the identifiers of on-premises storage devices, not depicted, and the identifiers of cloud storage devices, not depicted, are managed by the cloud volume list table T1200 and the on-premises volume list table T1300. The external device IDs may include those identifiers. Volume mapping may be specified from the identifiers of the storage devices, the SDS volume numbers, and the external device IDs.

In step S3, the management function unit 6320 specifies the relations between the databases, the tables, and the volumes and stores the specified result in the service-related list table T1500. In step S4, the management function unit 6320 detects triggers of snapshots in development environments and test environments, such as changes in the DDL and changes in the CI/CD, for example, and stores the triggers in the trigger list table T1100.

An example of conditions for detecting a DDL trigger according to the present invention will be described below.

Method (1): A built-in trigger function of a database is used.

The management function unit 6320 detects a change in the DDL and generates a function to be added to the trigger list table T1100, by using a built-in trigger function of a database.

The management function unit 6320 periodically reads the trigger list table T1100 and further carries out each step to create a snapshot.

A built-in trigger function of a database refers to a native function of automatically executing a sequence of predefined commands in response to a particular event such as an insertion, an update, or a deletion with regard to a particular table. When these trigger conditions are satisfied, the database immediately performs a related action. The action includes, for example, changing another table, recording a changed log, and performing a verifying task. With this automated process, the management function unit 6320 can keep data consistency between volumes and execute business logic without additional manual intervention.

Method (2): LogMiner is used.

The management function unit 6320 uses DB LogMiner, for example, to read a Redo log from a database that can be used with a volume. The management function unit 6320 targets the volume 3211 in the on-premises server 3000 or the volume 4211 in the cloud server 4000, for example.

The Redo log usually includes information regarding data changes, DDL changes, scans, and the saving of trigger information into the trigger list table T1100.

The management function unit 6320 can use built-in LogMiner of Oracle (registered trademark) or a third-party tool, for example.

LogMiner represents a database utility that reads and analyzes transaction logs such as Redo logs and archive logs, for example, to check a history of changes in a database. By analyzing these logs, it is possible to specify data changes such as insertions, updates, and deletions as with structural changes such as schema updates. This function is often used for the purposes of auditing, replication, and recovery, making it possible for the administrator to track or reproduce transactions and troubleshoot problems efficiently. The function may be provided by programmed source codes that the user has coded.

An example of detection of a CI/CD trigger will be described below.

Method (1):

The management function unit 6320 uses API for CI/CD tools such as Jenkins (registered trademark) and GitHub Actions (registered trademark), for example.

The management function unit 6320 acquires builds and commits.

The management function unit 6320 can detect a log of a pushed git event and use a Git log or a git diff command.

The management function unit 6320 can collect information regarding triggers from the above information source and save the collected information in the trigger list table T1100.

In step S5, the management function unit 6320 keeps periodically checking new triggers in the trigger list table T1100, detects which P-VOL belongs to a triggered table, by using the trigger list table T1100, the on-premises volume list table T1300, and the service-related list table T1500, and stores the P-VOL in Set 1 and the external device ID in Set 2.

In step S6, the management function unit 6320 detects a parent consistency group of volumes in Set 1 and adds the external device IDs of all volumes in the parent consistency group in Set 1 to the on-premises volume list table T1300. Specifically, the management function unit 6320 detects a parent consistency group by acquiring and specifying the CTG IDs indicated by the CTG IDs T1330 on the basis of the on-premises volume list table T1300 from the ID of the volume in Set 1. According to the present embodiment, consistency groups are set with regard to P-VOLs. However, there may be P-VOLs with regard to which no consistency groups are set. If no consistency groups are set with regard to P-VOLs, then the external device IDs of the S-VOLs of the copy pair of the P-VOL in Set 1 are added to Set 3.

In step S7, the management function unit 6320 starts a DB backup mode (hereinafter also abbreviated to a "backup mode"). The backup mode refers to a function that can be used by many database systems in order to keep data consistency while in snapshot or backup operation. Databases are temporarily placed in the "backup mode." Although the backup mode is not a strict requirement for the present embodiment, the backup mode can be useful in a particular scenario.

When the backup mode is effective, a database temporarily limits or redirects the writing of data and records them in a log, for example. A snapshot or copy acquired during this time now accurately reflects a stable consistent state of the database. When the copy or snapshot is completed, the management function unit 6320 finishes the backup mode and resumes normal operation. By using the backup mode that can thus be used, the risk of acquiring partial or inconsistent data is highly reduced, making subsequent testing, troubleshooting, or environment recovery more reliable. According to the present embodiment, the backup mode may not necessarily be indispensable.

In step S8, the management function unit 6320 splits the copy pairs of all the P-VOLs included in the parent consistency group confirmed in step S6. Splitting a copy pair (hereinafter also referred to as "copy pair splitting") refers to a process (also referred to as "splitting" according to the present embodiment) of temporarily severing or invalidating a replication link between a P-VOL and an S-VOL corresponding to the P-VOL.

Once the copy pair splitting is performed, changes that are in progress in the P-VOL are not transmitted to the S-VOL. This process effectively freezes and keeps at rest the S-VOL at a particular time, and is thus ideal when acquiring consistent snapshots of the S-VOL for backup, testing, and troubleshooting, for example, without preventing the P-VOL from operating continuously. When the necessary action is over, the management function unit 6320 rejoins or resynchronizes the P-VOL and the S-VOL to resume data replication between the P-VOL and the S-VOL. In step S9, the management function unit 6320 stops the backup mode.

The "external device IDs" that limit targets whose snapshots are to be created are the external device IDs of all the volumes included in the parent consistency group acquired in step S6. In step S10, the management function unit 6320 acquires SDS volume IDs mapped onto the external device IDs, by using the on-premises/cloud mapping table T1400, and carries out a snapshot creating process on the relevant SDS volumes. Then, the management function unit 6320 registers the trigger IDs representing the triggers obtained in step S4, snapshot acquisition times, and snapshot IDs in the snapshot acquisition times T1640 and the snapshot IDs T1610 in the snapshot detail table T1600. Moreover, the management function unit 6320 acquires the external device IDs in Set 2 and adds the details of the snapshots to the snapshot detail table T1600. In step S11, the volumes split in Set 1 are resynchronized.

According to the present embodiment, structured information table sets are used to automate and manage database snapshots necessary for development and test pipeline.

FIG. 4 is a diagram illustrating an example of a test environment screen displayed according to the present embodiment. The test environment screen illustrates an exemplary representation of a GUI that visualizes services, volumes, their relations, and user options for test environment development. The test environment screen represents an example of output results according to the present embodiment.

A display area G3100 represents a visualization of relations between services, apps, Pods, and volumes in the on-premises server 3000 for a first trigger. A display area G3200 represents a visualization of relations between services, apps, Pods, and volumes in a remote site for a second trigger different from the first trigger. The trigger list table T1100, the cloud volume list table T1200, the on-premises volume list table T1300, the on-premises/cloud mapping table T1400, and the service-related list table T1500 are used to visualize the components.

A display area G3110 and a display area G3210 illustrate an example of snapshots acquired according to the present embodiment. Using this test environment makes it possible to deploy the display area G3110 and the display area G3210 in the cloud server 4000 in a similar manner to local site display areas G3120 and G3220.

Providing a checkbox G3300A is checked, a setting display area G3300 displays conditions for the test environment at the date and time when the snapshots are acquired using a schema change as the first trigger.

Providing a checkbox G3400A is checked, a setting display area G3400 displays conditions for the test environment at the date and time when the snapshots are acquired using a schema change as the first trigger. When a test environment deployment button G2500 is clicked with a pointer P after a desired one of the checkboxes G3300A and G3400A has been checked, a user-defined script to be described later is called to deploy a test environment in the cloud server 4000 with use of the snapshots described above. For deploying a plurality of test environments, the checkboxes are checked again, and then, the test environment deployment button G2500 is clicked, whereupon the management function unit 6320 creates further snapshots from the above snapshots as copy sources, calling a user-defined script to be described later to deploy a test environment in the cloud server 4000.

The user-defined script includes a procedure of deploying a cloud instance or a virtual machine (VM), installing a database or an application, attaching a snapshot volume to a cloud instance or a VM, and recovering a database from the data of a snapshot volume.

The storage system according to the present embodiment includes the on-premises server 3000 as an example of an on-premises storage device having a plurality of P-VOLs 3211, S-VOLs 3215, P-VOLs 3212, and S-VOLs 3216, the cloud server 4000 as an example of a cloud storage device having a plurality of cloud volumes 4211 and 4212, and the management system 6000 for managing the P-VOLs 3211, the S-VOLs 3215, the P-VOLs 3212, and the S-VOLs 3216 in the on-premises server 3000 and the cloud volumes 4211 and 4212 in the cloud server 4000 and managing a function of transferring data from the P-VOLs 3211 and 3212 as examples of on-premises volumes to the cloud volumes 4211 and 4212. The management system 600 includes the management function unit 6320 for detecting a particular event and acquiring a snapshot volume of any of the volumes in the cloud server 4000. The management function unit 6320 is triggered by the detection of the particular event to specify at least some on-premises primary volumes (e.g., the P-VOLs 3211 and 3212) related to the particular event among the P-VOL 3211 and the P-VOL 3212 in the on-premises server 3000. The management function unit 6320 creates the S-VOLs 4213 and 4214 by acquiring snapshots of the P-VOLs 4211 and 4212 in the cloud server 4000.

With these configurations, the management function unit 6320 is triggered by the detection of the particular event to specify at least some P-VOLs 3211 and 3212 that can be affected by the particular event, and can acquire snapshots of the P-VOLs 4211 and 4212 in the cloud server 4000. Therefore, it is easy to specify volumes from which to acquire snapshots necessary to deploy test environments. Further, as a group of volumes whose snapshots are to be acquired for a test can automatically be identified, a test environment can automatically be deployed, a down time can be reduced, and test environments that are efficient and consistent can be guaranteed.

According to the above embodiment, the management function unit 6320 of the management system 6000 manages an external device manager function of causing the cloud volumes 4211 and 4212 to be virtually recognized as the on-premises volumes S-VOLs 3215 and 3216 and a replication function of transferring the data from the P-VOLs 3211 and 3212 to the S-VOLs 3215 and 3216. This makes it possible to acquire snapshots of the P-VOLs 4211 and 4212 connected as external devices, by using the external device manager function, and also to perform the same advantages as the advantages described above.

According to the above embodiment, the management function unit 6320 of the management system 6000 specifies a consistency group to which at least some on-premises primary volumes that have been specified belong, splits the copy pairs A13a and A13b of the P-VOLs 3211 and 3212 as examples of on-premises primary volumes belonging to the consistency group and the cloud volumes, and after snapshots of the cloud volumes 4211 and 4212 have been acquired, resynchronizes the copy pairs of the P-VOLs 3211 and 3212 as examples of on-premises volumes and the cloud volumes 4211 and 4212. The management function unit 6320 is thus triggered by the detection of a particular event to specify at least some P-VOLs 3211 and 3212 belonging to the consistency group 3210 that can be affected by the particular event. Therefore, it is easy to specify volumes from which to acquire snapshots necessary to deploy test environments. Further, as a group of volumes whose snapshots are to be acquired for a test can automatically be identified, a test environment can automatically be deployed, a down time can be reduced, and test environments that are efficient and consistent can be guaranteed.

According to the above embodiment, the management function unit 6320 of the management system 6000 detects changes in the schemas of the P-VOLs 3211 and 3212 used in databases, for example, as a particular event. The management function unit 6320 is thus triggered by the changes in the schemas to easily specify volumes from which to acquire snapshots necessary to deploy test environments.

According to the above embodiment, the management function unit 6320 of the management system 6000 detects an event (pipeline event) that may occur in CI/CD, as a particular event. The management function unit 6320 is thus triggered by CI/CD to easily specify volumes from which to acquire snapshots necessary to deploy test environments.

According to the above embodiment, the management function unit 6320 of the management system 6000 detects a change in a DDL as a particular event. The management function unit 6320 is thus triggered by a DDL to easily specify volumes from which to acquire snapshots necessary to deploy test environments.

According to the above embodiment, the management function unit 6320 of the management system 6000 starts creating a snapshot volume on the basis of a detected particular trigger while keeping alignment between the volumes included in the consistency group 3210. The management function unit 6320 is thus able to easily specify volumes from which to acquire snapshots necessary to deploy test environments without breaking consistency between the volumes.

The present invention is not limited to the embodiment described above, and covers various modifications and equivalent configurational details within the scope of the attached claims. For example, the embodiment described above has been described in detail for an easier understanding of the present invention, and the present invention should not necessarily be interpreted as being limited to anything inclusive of all the details described above. Moreover, components described in a parallel fashion according to the embodiment may be arranged such that at least one of the components may be connected in series to another component.

The present invention is applicable to a storage system and a storage control method in the field of a technology of acquiring snapshots for deploying test environments.

What is claimed is:

1. A storage system comprising:
an on-premises storage device having a plurality of on-premises volumes;
a cloud storage device having a plurality of cloud volumes; and
a management system that manages the plurality of on-premises volumes in the on-premises storage device and the plurality of cloud volumes in the cloud storage device and manages a function of transferring data from the plurality of on-premises volumes to the plurality of cloud volumes, wherein
the management system includes a management function unit that detects a particular event and that acquires a snapshot volume of any one of the volumes in the cloud storage device, and
the management function unit
specifies, using detection of the particular event as a trigger, at least some on-premises primary volumes related to the particular event among the plurality of on-premises volumes in the on-premises storage device, and
creates secondary volumes by acquiring snapshots of a plurality of cloud primary volumes in the cloud storage device.

2. The storage system according to claim 1, wherein
the management function unit manages a function of establishing connection with the cloud volumes as external devices, causing the cloud volumes to be virtually recognized as the on-premises volumes, and transferring data from the on-premises volumes to the cloud volumes.

3. The storage system according to claim 1, wherein
the management function unit specifies a consistency group to which the at least some on-premises primary volumes that have been specified belong, splits copy pairs of the on-premises primary volumes belonging to the consistency group and the cloud volumes, and resynchronizes the copy pairs of the on-premises volumes and the cloud volumes after the snapshots of the cloud primary volumes have been acquired.

4. The storage system according to claim 1, wherein
the management function unit detects a change in a schema of a primary volume used in a database, as the particular event.

5. The storage system according to claim 1, wherein
the management function unit detects an event that may occur in continuous integration/continuous delivery, as the particular event.

6. The storage system according to claim 1, wherein
the management function unit detects a change in a data definition language as the particular event.

7. The storage system according to claim 1, wherein
the management function unit starts creating a snapshot volume on a basis of the detected particular trigger while keeping alignment between a plurality of volumes included in a consistency group.

8. A storage control method for a storage system,
the storage system including
an on-premises storage device having a plurality of on-premises volumes,
a cloud storage device having a plurality of cloud volumes, and
a management system that manages the plurality of on-premises volumes in the on-premises storage device and the plurality of cloud volumes in the cloud storage device and manages a function of transferring data from the plurality of on-premises volumes to the plurality of cloud volumes,
the management system including a management function unit that detects a particular event and that acquires a snapshot volume of any one of the volumes in the cloud storage device,
the method comprising:
by the management function unit,
specifying, using detection of the particular event as a trigger, at least some on-premises primary volumes related to the particular event among the plurality of on-premises volumes in the on-premises storage device; and
creating secondary volumes by acquiring snapshots of a plurality of cloud primary volumes in the cloud storage device.

9. The storage control method according to claim 8, wherein
the management function unit manages a function of establishing connection with the cloud volumes as external devices, causing the cloud volumes to be virtually recognized as the on-premises volumes, and transferring data from the on-premises volumes to the cloud volumes.

10. The storage control method according to claim 8, wherein
the management function unit specifies a consistency group to which the at least some on-premises primary volumes that have been specified belong, splits copy pairs of the on-premises primary volumes belonging to the consistency group and the cloud volumes, and resynchronizes the copy pairs of the on-premises volumes and the cloud volumes after the snapshots of the cloud primary volumes have been acquired.

11. The storage control method according to claim 8, wherein
the management function unit detects a change in a schema of a primary volume used in a database, as the particular event.

12. The storage control method according to claim 8, wherein
the management function unit detects an event that may occur in continuous integration/continuous delivery, as the particular event.

13. The storage control method according to claim 8, wherein
the management function unit detects a change in a data definition language as the particular event.

14. The storage control method according to claim 8, wherein
the management function unit starts creating a snapshot volume on a basis of the detected particular trigger while keeping alignment between a plurality of volumes included in a consistency group.
